(19) United States
(12) Patent Application Publication
(10) Pub. No.: US 2024/0220950 A1
(43) Pub. Date: Jul. 4, 2024

(54) METHOD OF PULL-BASED REAL TIME PAYMENT AUTHORIZATION

(71) Applicant: American Express Travel Related Services Company, Inc., New York, NY (US)

(72) Inventor: Matthew Stephen BODELL, Sunrise, FL (US)

(73) Assignee: American Express Travel Related Services Company, Inc., New York, NY (US)

(21) Appl. No.: 18/148,767

(22) Filed: Dec. 30, 2022

(51) Int. Cl. G06Q 20/10; G06Q 20/40; G06Q 40/02

(52) U.S. Cl. CPC G06Q 20/102; G06Q 20/401; G06Q 40/02

(57) ABSTRACT

Disclosed herein are system, apparatus, article of manufacture, method and/or computer program product embodiments, and/or combinations and sub-combinations thereof, for allowing an account holder to authorize an entity to issue pull requests for funds to be transferred using real time payment rails. A first account representing a store of central bank digital currency (CBDC) of a first user may be linked with a second account representing a store of central bank digital currency (CBDC) of a second user. A request may be received, from one of the first and second user, to transfer CBDC from the first account to the second account. From another of the first and second user, an authorization may be received to transfer the CBDC. In response to the authorization, an entry may be written to a blockchain ledger effecting the requested transfer of the CBDC from the first account to the second account.

### TECHNICAL FIELD

This disclosure is generally directed to a method of payment authorization, and more particularly to allowing an account holder to authorize an entity to issue pull requests for funds.

### BACKGROUND

Within the financial service industry, recent years include expansive growth in customer-initiated account and access, transfer, and payment systems. Several different methods are available for transferring money between accounts electronically with the customer having control. Enhanced systems and methods of facilitating such transferring of money between customers or businesses would be desirable.

### SUMMARY

Provided herein are system, apparatus, article of manufacture, method and/or computer program product embodiments, and/or combinations and sub-combinations thereof, for allowing an account holder to authorize an entity to issue pull requests for funds to be transferred using real time payment rails.

Some embodiments are directed to linking a first account representing a store of central bank digital currency (CBDC) of a first user with a second account representing a store of central bank digital currency (CBDC) of a second user. In some embodiments, a request may be received, from one of the first and second user, to transfer CBDC from the first account to the second account. In some embodiments, from another of the first and second user, an authorization may be received to transfer the CBDC. In some embodiments, in response to the authorization, a blockchain ledger may be written to include an entry effecting the requested transfer of the CBDC from the first account to the second account.

Further features of the present disclosure, as well as the structure and operation of various embodiments, are described in detail below with reference to the accompany drawings. It is noted that the present disclosure is not limited to the specific embodiments described herein. Such embodiments are presented herein for illustrative purposes only. Additional embodiments will be apparent to persons skill in the relevant art(s) based on the teachings contained herein.

### BRIEF DESCRIPTION OF THE FIGURES

The accompanying drawings are incorporated herein and form a part of the specification.

FIG. 1A illustrates the architecture of using CBDC as a payment, according to some embodiments.

FIG. 1B illustrates the architecture of using CBDC as a payment, according to some embodiments.

FIG. 2 illustrates is a flowchart illustrating a process for a user requesting CBDC, according to some embodiments.

FIG. 3 is a flowchart illustrating a process 300 for allowing an account holder to authorize an entity to issue pull requests for funds to be transferred using real time payment rails, according to some embodiments.

FIG. 4 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for allowing an account holder to authorize an entity to issue pull requests for funds to be transferred using real time payment rails.

Several different methods are available for transferring money between accounts electronically. One method is wire transfer. Using wire transfer, an account holder can request that money be transferred out of the holder's account into another person's account. By making a request in this way, the account holder can “push” money into another's account. While sending money relatively quickly, wire transfer tends to be costly and involve a large transaction cost. Because wire transfer is normally a “push” system, the sender is normally required to provide account information for the recipient.

A second method to transfer money between accounts electronically is using Automated Clearing House (ACH) network. The Automated Clearing House is a U.S. financial network used for electronic payments and money transfers. Also known as “direct payments,” ACH payments are a way to transfer money from one bank account to another without using paper checks, credit card networks, wire transfers, or cash. The ACH network may allow for both “pull” and “push” transfers. For example, the recipient account may in certain instances the able to provide account information and request a transfer from the sender account. In this way, the ACH network may allow for “push” transfers, in addition to “pull” transfers.

However, the ACH network is not instantaneous. ACH normally takes several days to settle. And, even with same-day ACH, settlement may normally happen at the end of the business day. This is particularly problematic if the request is made outside of normal business hours. Because of this delay in settling ACH transactions, they may fail for insufficient funds.

A third method to transfer money between accounts electronically is using real time payments (RTP). The term “real-time payment” (RTP) is used to describe any account-to-account fund transfer that allows for the immediate availability of funds to the beneficiary of the transaction. Real-time payments offer a confirmation of funds via a real-time balance; once a payment is authorized, the payer's account reflects the deduction of funds instantaneously. Real time payments (RTP) are payments that are initiated and settled nearly instantaneously. A RTP rail is the digital infrastructure that may facilitate the RTP. One example RTP rail is RTP® available from The Clearing House Payments Company L.L.C. of New York, NY. Like wire transfers, RTP payments are “push” transactions.

Some RTP rails use central bank digital currencies (CBDC) in their operation. CBDC digital tokens, similar to cryptocurrency, issued by a central bank. They are pegged to the value of that country's fiat currency. In countries where CBDCs are implemented, CBDCs are legal tender and are convertible one-for-one into reserve balances or paper currency. CBDCs can be based on blockchain, but they do not need to be.

As mentioned above, ACH credit may push funds into an account, meaning the payer is responsible for initiating the transfer or funds to a business. The payer will push the money from their bank account to the payee. ACH debit may pull funds out of an account. With a payee's authorization, a payer may collect payments directly from the payee's account. The credit or debit process may fail in either case if the accounts do not hold enough money. Additionally, the credit and debit process are not instantaneous and may take days to fulfill.

As also mentioned above, a wire transfer is also available as a method of electronic funds from one person or entity to another. Specifically, the wire transfer may be from one back account to another bank account or through a transfer of cash at a cash office. Wire transfer may operate as follows: an entity wanting to do a transfer tells a bank such. The sending bank transmits a message, which includes the relevant information to the transfer, to the receiving bank. The transfer is not instantaneous as it may take several hours or days to move the money from the sender to the receiver's account. The sending bank may collect a fee separate from the funds being transferred and the receiving bank may deduct fees from the money being transferred. A wire transfer may become costly.

An alternative to these payments may involve using a central bank digital currency (CBDC). A CBDC is a digital currency that may be issued by a central bank, rather than a commercial bank. CBDC is similar to Bitcoin or other similar blockchain-based cryptocurrencies, but is not a virtual currency or cryptocurrency such that CBDC is issued by a state or government. Most CBDC implementations do not use a distributed ledger, such as blockchain.

In some possible implementations, CBDC may be recorded using blockchain. A blockchain is a type of distributed ledger technology (DLT) involving growing a list of records, often referred to as blocks, that may be securely linked together using cryptography. Each block may contain a cryptographic hash of the previous block, a timestamp, and a transaction date. The timestamp therefore proves that the transaction date existed when the block was actually created. Since each block contains information about the previous block, they form a chain, with each additional block being linked to the one before. Most importantly regarding blockchains is that once the transaction is recorded, the data cannot be altered retroactively without altering all subsequent blocks.

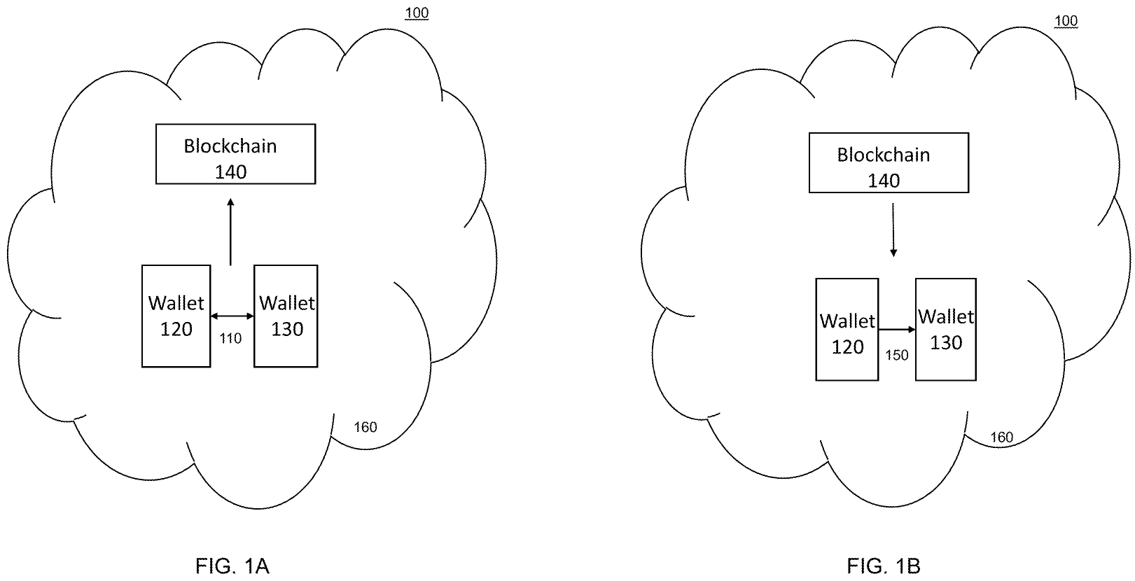

FIG. 1A illustrates the architecture 100 of using CBDC as a payment, according to some embodiments. There are various embodiments that can describe using CBDC as a payment described herein.

For a first example, two users may transfer CBDC between each other. Specifically, a first digital wallet 120 and a second digital wallet 130 may be in an app on a user's mobile phone or the like. For example, a user may be a member of a credit card or bank company, which has an application, or app, available on the user's mobile phone. The user may already have an account associated with such an app or sign up for account once they decide to conduct a transaction. Once an account has been created in the app by the user, the user may create a wallet within the account, which has a specific address associated with the wallet. The specific address may only be associated with that specific wallet. Within the wallet, the user may add or load currency to the wallet, and that currency may be CBDC. The advantage of using CBDC may be, but not limited to, that there is no transaction fee. The wallet now has a balance.

Now that the user has a balance, the user may choose to make a payment to a another user. As will be described in greater detail below, the user may give permission, or authorization, for the merchant to pull funds directly from the account and this may be considered a transaction. The transaction will appear in the blockchain 140 such that the transaction history may be seen. Access to the funds is immediate.

To send CBDC in a peer-to-peer manner, the first digital wallet 120 and a second digital wallet 130 may be have a link 110. Linking accounts allows movement of funds between the accounts. The user of the first digital wallet 120 may login to the app where the first digital wallet 120 is located. Within the app, is typically an option to link 110, or add, an external account, which may be for example but not limited to, the account of the seond digital wallet 130. To link 110 the first digital account 120 to the second digital wallet 130, identification information, such as account number, user name, phone number or the like, of the account of the second digital wallet 130 is required.

A step-two verification process may exist, but is not required, where the user of the second digital wallet 130 confirms that the two wallets should be linked. Specifically, a link request from the second user's digital wallet 130 in an app may be sent to the first user's digitial wallet 120 in their app. The first user must authorize that the accounts are linked to each other. A record of the authorization may be stored in a data store accessible to the first and second digital wallets 120 and 130 to establish link 110. By linking the first digital wallet 120 to the second digital wallet 130, or vice versa, the two digital wallets may conduct transactions between them at any time until one user cancels the linkage.

For example, once the digital wallets are linked, a user may send another user funds, as opposed to a merchant, which will be described herein later. Once linked, they do not need to be linked again for every transaction. If the accounts are not linked, no fraud can occur, but instead the accounts are authorized to transmit and receive funds. The link 110 does not occur, for example on the blockchain, but instead between the apps. This information about linking accounts or the like, may be stored in a datastore of the actual owner of the app that contains the digital wallet. The datastore may be a repository for persistently storing and managing collections of data which include not just repositories such as databases but also simpler store types such as simple files, emails, account information, or the like.

Once the first digital wallet 120 and second digital wallet 130 have a link 110, they may have transactions occur between them, such as sending or receiving CBDC between the first digital wallet 120 and the second digital wallet 130. Specifically, the user of the first digital wallet 120 may send funds to the user of the second digital wallet 130 because the two users are conducting a transaction between themselves, such as purchasing a pair of tennis shoes or paying someone back for dinner. The first digital wallet 120 wants to transfer funds to the second digital wallet 130. If the CBDC exists in the account of the first digital wallet 120, the transaction may be written to a blockchain 140. Writing to the blockchain includes blocks, which are securely linked together. In each block, is a cryptographic hash of the previous block, a timestamp, and transaction data describing a quantity of CBDC being transferred, and a source and destination wallet for the transfer. The timestamp proves that the transaction data existed when the block was created. In this way, the first digital wallet 120 and second digital wallet 130 may transfer 150 funds between them and a transaction record is preserved in the blockchain. The user of the first digital wallet 120 may then purchase the pair of tennis shoes from the user of second digital wallet 130, who has now sold them or now the user of the first digital wallet 120 has paid back the user of the second digitial wallet 130 for dinner.

FIG. 1B illustrates the architecture 100 of using CBDC as a payment, according to some embodiments.

When the user of the first digital wallet 120 sends or transfers 150 funds to the second digital wallet 130, this may be referred to as a push transaction or push request. On the other hand, when the user of the first digital wallet 120 requests funds from the second digital wallet 130, this may be referred to as a pull transaction or a pull request.

For a second example, the user may choose to make a payment to a merchant using digital wallets. In this example, the first digital wallet 120 of the user and the second digital wallet 130 of the merchant may have a one-time link 110 between them. Here, a one time link 110 may be advantageous as the user or the merchant does not want the permanent linkage of the two accounts as maybe the user is only using the merchant one time.

To have a one-time link 110, either the merchant or the user may send the identification information to the other using the digital wallet in the app. Either the user or the merchant may approve or verify the transaction for a one-time transfer.

The architecture 100 of the examples described herein may be in the cloud 160 or the like.

As opposed to the user side, which includes a user interface of the appls, the backend side is different. The owner of the app, such as a bank or credit card company, may perform the actual pull request from the user or the merchant. As the owner, they have access to the addresses of customer's wallets, which may be stored in a datastore and have access to the wallet itself. Additionally, the owner of the app has access to the CBDC. The request between the users is done over a network and transmitted to the owner of the app. When the bank or credit card company sees that a merchant or user is requesting a pull or a push request, the bank or credit card company verifies that the accounts are actually linked before allowing the transaction to occur. Once verified, the transaction may occur. The transaction details are stored in the blockchain of the bank or credit card company.

Additionally, the blockchain of the bank or credit card company is not a publicly available blockchain due to customer privacy desires. The blockchain is available only to see by the bank or credit card company. The transaction occurs on the blockchain and not, for example, server to server. Again, if the merchant or user's wallet address requests funds be transferred, it is checked whether the link 110 has been approved and then the transaction would be approved to the blockchain. Only those using CBDC may write to that particular blockchain and the transaction details may be anonymized and, for example, you may not see the name of the person or wallet conducting the transaction, but instead, the cryptographic hash and timestamp.

Using CBDC according to embodiments is different than, an ACH request for example. In the ACH request, the money transfer is not immediate. A line of credit is extended instead during an ACH push or pull request. The purchase itself may be instantaneous, but the money required is actually not there until hours or days later. Once the money is received, the line of credit is essentially closed. Thus, by reducing network latency in this way, embodiments offer a technical improvement to enable “push” or “pull” transactions to be processed more quickly than existing techniques.

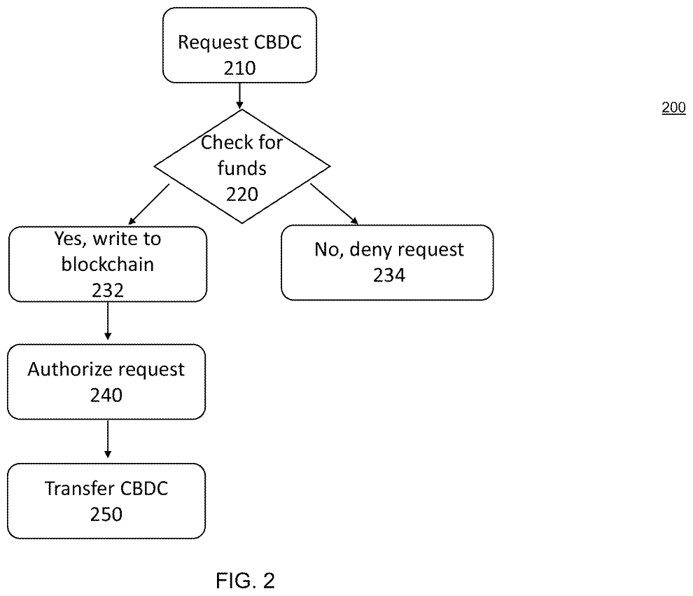

FIG. 2 is a flowchart illustrating a process 200 for a user requesting CBDC, according to some embodiments.

In 210, CBDC may be requested to be transferred from a first user to a second user in a transaction. The first or second user may be another user, a credit card company, a bank, a merchant, or the like. Specifically, the user of a first digital wallet 120 may request to transfer funds to the user of a second digital wallet 130 within an app on their mobile device. This request to transfer funds may occur when purchasing a product from another user or merchant, reimbursing a friend, hiding money from a loved one, or the like. Within the app may be a button or the like to initiate or receive a transfer. The users may receive a message, notification or pop-up that a push or pull request is occurring.

In 220, a check for funds may be made. This checking may be done by the app that holds the funds being transferred. For example, a user's account information and details may be in a datastore of the owner of the app. The datastore may include, but is not limited to balances, transaction details, account information, or the like. The app may see in the datastore the balance of the account being used to transfer funds.

If the funds are available, in 232, then the transaction may be written to a blockchain 140. Specifically, the app has verified that the funds exist in the first digital wallet 120 and the transaction may be written to the blockchain 140. The block in the blockchain includes a cryptographic hash, a timestamp, and a transaction.

Once the transaction is written, in 240, the request may be authorized. Specifically, the authorization allows for the funds from the first digital wallet 120 to be transferred to the second digital wallet 130.

Once the authorization occurs, in 250, the CBDC may be transferred. Specifically, the funds from the first digital wallet 120 may be actually transferred to the second digital wallet 130.

If the funds are not available, in 234, then the transaction may be denied.

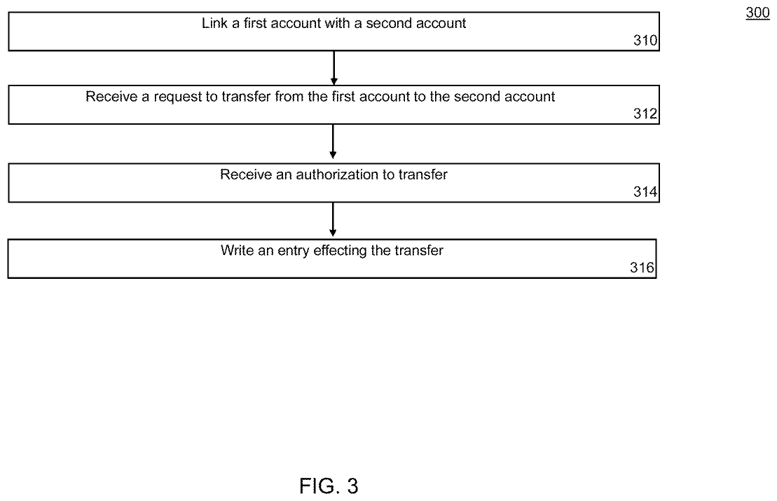

FIG. 3 is a flowchart illustrating a process 300 for allowing an account holder to authorize an entity to issue pull requests for funds to be transferred using real time payment rails, according to some embodiments.

In 310, a first account may be linked with a second account. The first account may represent a store of CBDC of a first user and the second account may represent a store of CBDC of a second user. The linking may further include notifying the first user of the request. The linking may further include storing an indication from the sender indicating approval for the recipient to withdraw CBDC. The first account may be a first digital wallet and the second account may be a second digital wallet. The first digital wallet and the second digital wallet may be linked.

In 312, a request to transfer funds from the first account to the second account may be received. The request may be from one of the first and second user. The funds may be CBDC. The request may be a push or pull request from the first account. The request may include at least one of an amount of the request for funds, a timestamp of the request for funds, a frequency of the request for funds, an identification of the request for funds, or a definition of the request for funds.

In 314, an authorization to transfer funds may be received. The receiving may be from the other first and second user. The authorization of the request may be authorized via a digital wallet of the first account.

In 316, an entry effecting the transfer may be written. The entry may be written to a blockchain ledger. The entry may include the requested transfer of the CBDC from the first account to the second account.

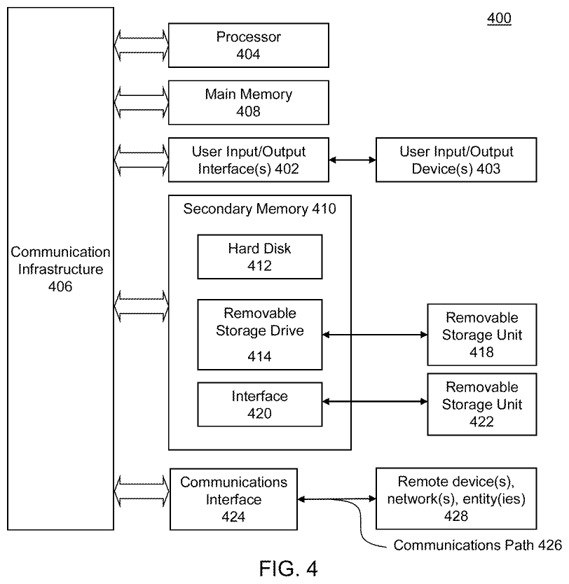

Various embodiments may be implemented, for example, using one or more well-known computer systems, such as computer system 400 shown in FIG. 4. For example, the media device 106 may be implemented using combinations or sub-combinations of computer system 400. Also or alternatively, one or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400 or processor(s) 404), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method for payment authorization, comprising:
linking a first account representing a store of central bank digital currency (CBDC) of a first user with a second account representing a store of central bank digital currency (CBDC) of a second user;
receiving a request, from one of the first and second user, to transfer CBDC from the first account to the second account;
receiving, from another of the first and second user, an authorization to transfer the CBDC; and
in response to the authorization, writing, to a blockchain ledger, an entry effecting the requested transfer of the CBDC from the first account to the second account.

2. The computer implemented method of claim 1, further comprising:
notifying the first user of the request.

3. The computer implemented method of claim 1, the linking comprising:
storing an indication from the sender indicating approval for the recipient to withdraw CBDC.

4. The computer implemented method of claim 1, wherein the request is a push or a pull request from the first account.

5. The computer implemented method of claim 1, wherein the request comprises at least one of an amount of the request for funds, a timestamp of the request for funds, a frequency of the request for funds, an identification of the request for funds, or a definition of the request for funds.

6. The computer implemented method of claim 1, wherein the first account is a first digital wallet and the second account is a second digital wallet.

7. The computer implemented method of claim 6, wherein the first digital wallet and the second digital wallet are linked.

8. The computer implemented method of claim 1, wherein the authorization of the request is authorized via a digital wallet of the first account.

9. A system, comprising:
a memory; and
at least one processor coupled to the memory and configured to:
link a first account representing a store of central bank digital currency (CBDC) of a first user with a second account representing a store of central bank digital currency (CBDC) of a second user;
receive a request, from one of the first and second user, to transfer CBDC from the first account to the second account;
receive, from another of the first and second user, an authorization to transfer the CBDC; and
in response to the authorization, write, to a blockchain ledger, an entry effecting the requested transfer of the CBDC from the first account to the second account.

10. The system of claim 9, further comprising:
notifying the first user of the request.

11. The system of claim 9, the linking comprising:
storing an indication from the sender indicating approval for the recipient to withdraw CBDC.

12. The system of claim 9, wherein the request is a push or a pull request from the first account.

13. The system of claim 9, wherein the request comprises at least one of an amount of the request for funds, a timestamp of the request for funds, a frequency of the request for funds, an identification of the request for funds, or a definition of the request for funds.

14. The system of claim 9, wherein the first account is a first digital wallet and the second account is a second digital wallet.

15. The system of claim 14, wherein the first digital wallet and the second digital wallet are linked.

16. The system of claim 9, wherein the authorization of the request is authorized via a digital wallet of the first account.

17. A non-transitory computer-readable device having instructions stored thereon that, when executed by at least one computing device, causes the at least one computing device to perform operations comprising:
linking a first account representing a store of central bank digital currency (CBDC) of a first user with a second account representing a store of central bank digital currency (CBDC) of a second user;
receiving a request, from one of the first and second user, to transfer CBDC from the first account to the second account;
receiving, from another of the first and second user, an authorization to transfer the CBDC; and
in response to the authorization, writing, to a blockchain ledger, an entry effecting the requested transfer of the CBDC from the first account to the second account.

18. The non-transitory computer-readable device of claim 17, further comprising:
notifying the first user of the request.

19. The non-transitory computer-readable device of claim 17, the linking comprising:
storing an indication from the sender indicating approval for the recipient to withdraw CBDC.

20. The non-transitory computer-readable device of claim 17, wherein the request is a push or a pull request from the first account.

21. The non-transitory computer-readable device of claim 17, wherein the request comprises at least one of an amount of the request for funds, a timestamp of the request for funds, a frequency of the request for funds, an identification of the request for funds, or a definition of the request for funds.

22. The non-transitory computer-readable device of claim 17, wherein the first account is a first digital wallet and the second account is a second digital wallet.

23. The non-transitory computer-readable device of claim 22, wherein the first digital wallet and the second digital wallet are linked.

24. The non-transitory computer-readable device of claim 17, wherein the authorization of the request is authorized via a digital wallet of the first account.
